(19) United States
(12) Patent Application Publication
(10) Pub. No.: US 2007/0076858 A1
(43) Pub. Date: Apr. 5, 2007

(54) Method for supporting the name delivery feature for mixed tdm networks/ sip centrex communication architectures.

(76) Inventor: Klaus Hoffmann, Munich (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/570,914

(22) PCT Filed: Aug. 30, 2004
(86) PCT No.: PCT/EP04/51957

§ 371 Date: Mar. 3, 2006

(30) Foreign Application Priority Data
Sep. 5, 2003 (DE) 103 41 087.2

(51) Int. Cl. H04M 1/64

(52) U.S. Cl. 379/88.19

(57) ABSTRACT

According to prior art, name information is displayed instead of dialling information, by means of the Name Delivery feature, for subscribers to conventional TDM CENTREX communication architectures. The mixed operation of TDM/SIP CENTREX communication architectures does not yet support this feature. The invention remedies this in that the name information is transmitted in protocol elements of the SIP protocol and is supplied to the called subscriber by means of a logic. Said logic determines whether the information is displayed or not.

### CROSS REFERENCE TO RELATED APPLICATIONS

This application is the US National Stage of International Application No. PCT/EP2004/051957, filed Aug. 30, 2004 and claims the benefit thereof. The International Application claims the benefits of German application No. 10341087.2 DE filed Sep. 5, 2003, both of the applications are incorporated by reference herein in their entirety.

### FIELD OF INVENTION

The present invention relates to a method for supporting the name delivery feature for mixed TDM networks/SIP CENTREX communication architectures.

### BACKGROUND OF INVENTION

More recent communication architectures provide for the separation of call-processing networks in communication service related units and the transport of the payload (Bearer Control). This results in a decomposition/separation of call set-up and medium or bearer set-up. The payload can be transmitted (through-connection of the traffic channel) via different high bit rate transport technologies such as, for example, ATM, IP, Frame Relay. With a separation of this type, the telecommunication services currently used in narrow band networks can also be realized in broadband networks. Thereby the subscribers are connected either directly (e.g. via a DSS1 protocol) or via exchanges designed as Media Gateway Controllers (MGC) (e.g. via the ISUP protocol). The payload itself is converted by the Media Gateways (MG) used in the respective transport technology. The Media Gateways are controlled by respectively allocated Media Gateway Controllers (MGC). The Media Gateway Controllers use the standard protocols, such as, for example, the MGCP protocol or the H.248 protocol to control the Media Gateways. In order to communicate between each other, the Media Gateway Controllers use an ITU standardized BICC (Bearer Independent Call Control) protocol, which is a further development of an ISUP protocol. The BICC protocol is formed from several standardized protocols and thus comprises a protocol family.

At the IETF committee on standardization, protocols suitable for the BICC protocol emerged with the SIP and SIP-T protocols. The SIP-T protocol (RFC 3204) represents an addition to the SIP protocol (RFC 3261). Using the SIP-T protocol, it is possible to transmit ISUP messages—in contrast to with SIP protocol. In general ISUP messages are transmitted by means of tunnels, i.e. by transparent split-lot transfer. Preferably the ISUP-messages issued by a PSTN subscriber are held and supplied to the receiving PSTN subscriber together with a bearer message (INFO Method, RFC 2976). A general network configuration with TDM-/IP networks of this type is shown in FIG. 1. Here, by way of example, 2 PSTN networks are shown and in each respective network there are several PSTN subscribers arranged in the usual manner. These are connected to the local exchanges, LE, which are, in turn, connected to the transit exchanges, TX. In the transit exchanges, TX, the separation is now made between signaling information and payload. The transit exchange TX supplies the signaling information directly via an ISUP protocol to a respectively allocated Media Gateway Controller MGC (the A or B side). The payload is transmitted to a Media Gateway MG (arranged at the input side) (the A or B side), that functions as an interface between TDM network and an ATM or IP transmission network, where it is transmitted in packet mode via the respective transmission network (ATM or IP). The Media Gateway MG of the A side is controlled by the respectively allocated Media Gateway Controller MGC of the A side as is the Media Gateway MG of the B side by the Media Gateway Controller MGC of the B side allocated to. In the event that the payload is transmitted from Media Gateway MG of the A side to the Media Gateway MG of the B side, then again under the control of the Media Gateway Controllers MGC of the B side allocated to the Media Gateway MG of the B side, said payload is converted into a TDM data stream and supplied to the PSTN subscriber in question. The data transmitted between the Media Gateway Controller MGC and the respectively allocated Media Gateway is supported by a standardized protocol. This can be, for example, the MGCP or the H.248 protocol. A BICC protocol (or possibly ISUP+ protocol), a SIP or SIP-T protocol can be used as standardized protocols between the two Media Gateway Controllers MGCs. Further devices such as proxy devices (SIP world) and/or CMN exchanges (Call Mediation Node, ISUP/BICC world) can be switched between the two Media Gateway Controllers. In principle, it is desirable that the features known from the TDM world can also be used in the IP world. The Name Delivery feature, known to traditional (TDM) CENTREX subscribers, is presented as an example of this. Hereby, under a CENTREX (Central Office Exchange) configuration, is to be understood a configuration that includes the realization of features of a private branch exchange in subscriber exchanges in the public network. If the lines of a user group are connected with each other via CENTREX exchanges and the public telephone network, one refers to this as a Wide Area CENTREX. Potential CENTREX services users are, therefore:
groups with frequent change of location.
large interconnected complexes such as high-rises, technology and media centers, airports,
groups with decentralized structures which generate heavy internal traffic between the different locations.

In addition FIG. 1 shows the connection of a SIP CENTREX configuration as made via a SIP proxy server to a Media Gateway Controller MGC. The information is exchanged between the SIP subscribers of a SIP CENTREX configuration using the SIP protocol. All the subscriber related data of the CENTREX configuration is managed and maintained in the SIP proxy server.

### SUMMARY OF INVENTION

In a configuration of this type according to FIG. 1, there is the problem that in the mixed operation (Interworking) of TDM networks/IP networks/SIP CENTREX configurations/TDM CENTREX configurations, it is not possible to use the Name Delivery feature for CENTREX configurations known from the TDM world, as the necessary definitions have not yet been made.

An object of the invention is to find a way to enable the Name Delivery feature also to be used for networks with mixed TDM configurations/SIP CENTREX configurations.

An object of the invention is achieved by the features specified in the independent claim.

The advantage of the invention is to be found in the fact that when SIP CENTREX configurations are used, any subscriber (SIP or traditional TDM subscriber) has the name of the other subscriber (Partner) displayed to him/her. A further advantage of the invention is to be seen in the fact that the Name Delivery feature can also be used without limitation in ISUP/BICC/H323 networks while interworking with SIP network. Thereby, the Name Delivery feature includes the sub-feature “Calling Name” (name of the subscriber calling is displayed) and also “Connected Name” (name of the subscriber called is displayed when call taken).

Advantageous developments of the invention are specified in the dependent claims.

### BRIEF DESCRIPTION OF THE DRAWINGS

The invention is explained in greater detail below with reference to an exemplary embodiment illustrated in a figurative manner, in which;

FIG. 1 shows the relationships between 2 PSTN networks between which an Internet network is arranged, and with a SIP CENTREX configuration,

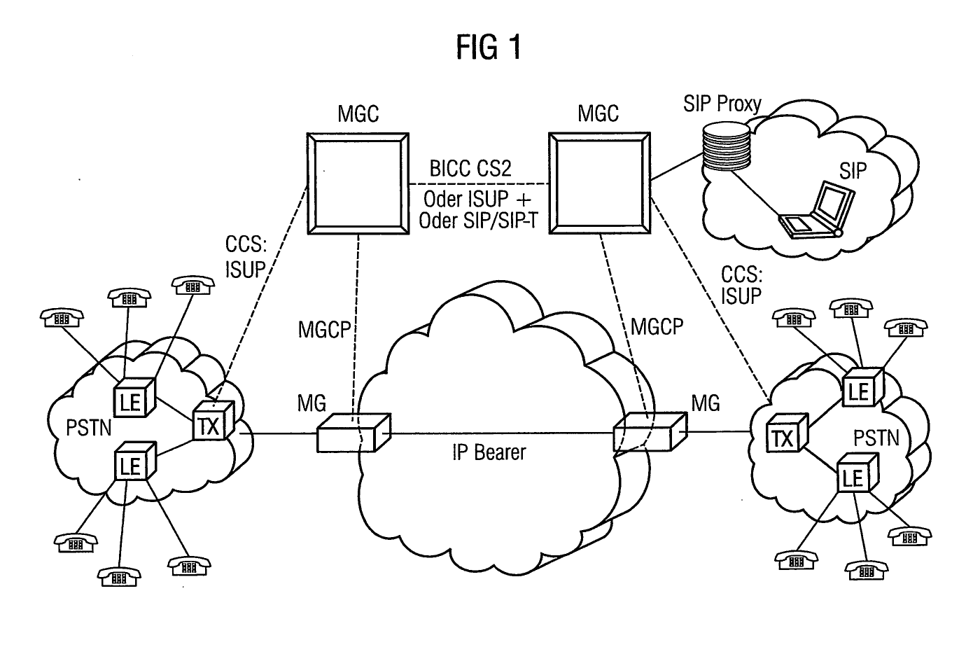

FIG. 2 shows the connection of a SIP CENTREX configuration to an Internet network with the information elements necessary to realize the Name Delivery feature

### DETAILED DESCRIPTION OF INVENTION

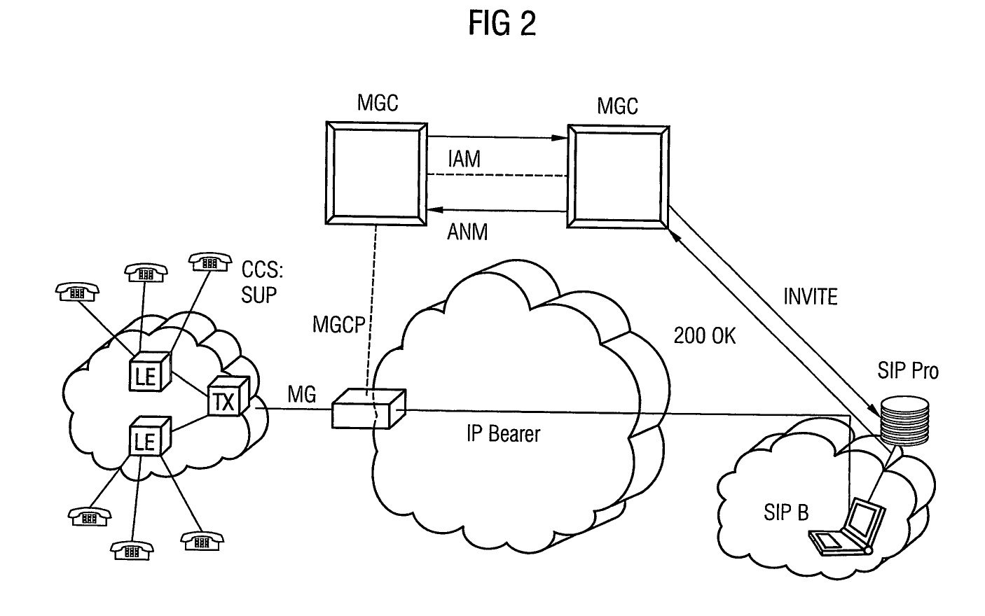

According to FIG. 2, the invention is explained in more detail with reference to an exemplary embodiment. It is hereby assumed that the subscriber of a TDM network (A side) calls the SIP subscriber (B side) of a SIP CENTREX configuration—in this case the subscriber SIP B. In this case, the signaling connection is routed via a SIP proxy (application server) server that supports the Name Delivery feature.

To realize this, first it is necessary to decide on the definitions according to TABLE 1 for the mapping for the transition ISUP/BICC to SIP and vice versa. The mapping is controlled in the Media Gateway Controller MGC of the B side (although the controller functionality is not shown here as there is no Media Gateway present, the device MGC of the B side is marked as Media Gateway Controller). As, according to prior art (ISUP/BICC), the Name Delivery feature for TDM CENTREX configuration is controlled via proprietary solutions, the name information is held in different protocol elements of the ISUP/BICC protocol. By way of example, two providers AI, A2 are displayed. In the case of A1, the name information is held in the ISUP/BICC protocol element “CallingName”, in the case of a provider A2 in the ISUP/BICC protocol element “CTX coding/decoding” (APP parameter (application transport parameter) based on ITU-T Recommendation Q.765). In the latter case, the name information is also held for the sub-feature “Connected Name”.

TABLE 1

| Provider | ISUP/BICC | SIP |
|---|---|---|
| A1 | CallingName | Display field in FROM |
| | | header/privacy header |
| A 2: CTX | CTX coding/ | Display field in FROM |
| ASE calling name | decoding | header/privacy header |
| A 2: CTX | CTX coding/ | Display name of the |
| ASE connected name | decoding | CONTACT Header/ |
| | | privacy header |

According to the invention (TABLE 1, right-hand column) provision is made in a first step for the name information for the sub-feature “Calling Name”, to be transmitted (mapping), in principle, into the protocol element of the SIP protocol “Display field in FROM header/privacy header”. In the case of the sub-feature “Connected Name”, the name information should be held in the SIP protocol element “Display name of the CONTACT Header/privacy header”.

In a second step, the subsequent actions are displayed in TABLE 2. The name information is supplied in the SIP protocol elements “Display field in FROM header/privacy header” to the proxy server SIP proxy via the SIP “INVITE” message. This first checks whether the called subscriber SIP B has allowed or applied for the display of the name of the calling subscriber (chargeable service). This is possible as the proxy server has stored the relevant data for this in a database. This can be an internal database in the proxy server itself, but it can also be externally connected to the proxy server. Information can also be stored in the database about whether the calling subscriber wants his/her name to be displayed or not. If the called subscriber SIP B does not allow the name of the calling subscriber to be displayed, the proxy server removes the name information from the SIP protocol element “Display field in FROM header/privacy header”.

Otherwise the name display is removed from the database and entered into the protocol element “Display field in FROM header/privacy header”. If the name display is already there, then no intervention is made. The name information is supplied to the called subscriber SIP B in the protocol element “Display field in FROM header/privacy header” and displayed on the terminal device.

TABLE 2

| | Proxy server (SIP proxy) | |
|---|---|---|
| SIP | Database query | SIP |
| FROM header/ | Is the Name Delivery feature | Add or remove |
| privacy header | (Calling Name) desired by | Display field in |
| | called subscriber? | FROM header/ |
| | | privacy header |
| CONTACT | Is the Name Delivery feature | Display name |
| Header/ | (Connected Name) desired by | of the |
| privacy header | called subscriber? | CONTACT Header/ |
| | | privacy header |

In the following, it is now assumed that the called subscriber SIP B accepts the call. The name information of the called SIP subscriber SIP B is routed via the SIP handshake message 200 OK and analyzed in the proxy server. If the name display is allowed at the calling subscriber, then said information is entered into the SIP protocol element “Display name of the CONTACT Header/privacy header”, or removed if the display is to be suppressed.

It should be noted that the invention can also be used if there is no ISUP/BICC protocol between the PSTN subscriber (ISDN, analogue subscriber or also mobile communications subscriber) and the SIP subscriber. This means that the method is then carried out within the exchange. The interworking of NextGenerationNetwork subscribers such as VoDSL, H323 etc. to SIP or SIP-T is thus also possible.

In the method just described, the method procedures are separated in the Media Gateway Controller and the proxy server. This separation is, however, not mandatory, the method procedure can also take place in a single device.

1-9. (canceled)

10. A method for supporting a Name Delivery feature between a TDM network connected to SIP CENTREX configurations, the Name Delivery feature including name information, comprising:
mapping between the name information located in a plurality of information elements of a transmission protocol and a SIP protocol; and
determining from subscriber related information whether to suppress or approve the name information in the SIP protocol.

11. The method according to claim 10, wherein the Name Delivery feature includes a Calling Name sub-feature and a Connected Name sub-feature.

12. The method according to claim 10,
wherein the mapping is occurs between the name information of a first sub-feature into a first information element of the SIP protocol, and
wherein the mapping is occurs between the name information of a second sub-feature into a second information element of the SIP protocol.

13. The method according to claim 12, wherein an “INVITE” SIP message includes the name information of the first sub-feature and an “200 OK” SIP message includes the name information of the second sub-feature.

14. The method according to claim 13, wherein the first sub-feature is Calling Name and the second sub-feature is Connected Name.

15. The method according to claim 13, wherein the first information element is “Display field in FROM header/privacy header” and the second information element is “Display name of the CONTACT header/privacy header”.

16. The method according to claim 10, wherein an “INVITE” SIP message includes the name information of a first sub-feature and an “200 OK” SIP message includes the name information of a second sub-feature.

17. The method according to claim 16, wherein the first sub-feature is Calling Name and the second sub-feature is Connected Name.

18. The method according to claim 10, further comprising providing a SIP proxy server connected to a database.

19. The method according to claim 18, wherein the database includes subscriber related data for a SIP CENTREX configuration subscriber and a TDM network subscriber.

20. The method according to claim 10, wherein the mapping occurs in a Media Gateway Controller (MGC).

21. The method according to claim 18, wherein the proxy server determines whether the name information is suppressed or approved.

22. The method according to claim 10, wherein the transmission protocol is selected from the group consisting of: BICC/ISUP protocol, H.323 protocol, DSS1 protocol, and a mobile communication application supporting protocol
